(19) United States
(12) Patent Application Publication
(10) Pub. No.: US 2019/0386260 A1
(43) Pub. Date: Dec. 19, 2019

(54) PACKAGING MATERIAL FOR BATTERY, SOFT PACK BATTERY AND BATTERY THERMAL CONTROL DEVICE

(71) Applicant: Yanjun XIE, Shanghai (CN)

(72) Inventor: Yanjun XIE, Shanghai (CN)

(21) Appl. No.: 16/082,232

(22) PCT Filed: Mar. 4, 2017
(86) PCT No.: PCT/CN2017/075659

§ 371 Date: Sep. 4, 2018

(30) Foreign Application Priority Data
Mar. 4, 2016 (CN) 201610121995.6
May 8, 2016 (CN) 201610296410.4
May 16, 2016 (CN) 201610316513.2
Jun. 15, 2016 (CN) 201610427155.2
Nov. 28, 2016 (CN) 201611058586.2

(51) Int. Cl. H01M 2/02; B32B 7/12; B32B 15/085; B32B 15/088; B32B 15/18; B32B 15/20; H01M 10/613; H01M 10/625; H01M 10/647; H01M 10/6567; C22C 21/10

(52) U.S. Cl. CPC H01M 2/0287; B32B 7/12; B32B 15/085; B32B 15/088; B32B 15/18; B32B 15/20; H01M 2220/20; H01M 10/625; H01M 10/647; H01M 10/6567; C22C 21/10; B32B 2307/714; B32B 2457/10; H01M 10/613

(57) ABSTRACT

Provided is a battery packaging material for packaging a battery, in particular a packaging material for a soft pack battery used in a vehicle and a soft pack battery thermal management system. With regard to the defect of an insufficient corrosion resistance of a battery packaging material in the prior art, particularly provided is a solution of an aluminum plastic composite film for packaging a battery as follows: that is to say, a battery packaging material, and the battery packaging material comprises an aluminum foil layer and a plastic layer compounded on the surface of the aluminum foil layer, wherein the aluminum foil layer is formed from an aluminum alloy with corrosion resistance to cooling water.

### TECHNICAL FIELD

The invention relates to a battery packaging material and a soft pack battery, in particular to a soft pack battery packaging material and a soft pack battery that can be used for immersing in cooling water, such as a water cooling system in the field of vehicle power batteries and energy storage batteries.

### BACKGROUND

The thermal management of the power battery is one of the core technologies of the power battery. The current cooling method of the soft-pack battery is more air-cooled. Even if it is water-cooled, the water-cooled board is used to contact the battery for heat exchange. In this heat exchange mode, the corresponding contact thermal resistance is high and the heat exchange efficiency is low. In view of the prior art, there is no application in which a soft-battery battery is directly immersed in water or an antifreeze solution, and there is no special aluminum plastic film suitable for it.

In the prior art, an aluminum plastic film for packaging a soft-pack battery is generally an 8-series aluminum alloy aluminum foil. After the aluminum foil is annealed, the aluminum foil is a soft aluminum foil, and the punching depth is good. At present, battery packaging materials are mainly considered electrolyte corrosion resistance, the main technical program is to modify the physical or chemical means to form a corrosion-resistant layer on the side of the packaging material toward the electrolyte, its role is to prevent the electrolyte from corroding the inner surface of the aluminum foil and resulting in aluminum plastic peeling between the film layers. The outermost layer of existing aluminum plastic film contains protective plastic films such as polyamide. These plastic protective films have poor resistance to hydrolysis and are prone to hydrolysis failure if they are exposed to water for a long time. The existing aluminum plastic film aluminum foil has high iron content and poor water corrosion resistance, and it is likely to cause corrosion perforation when it encounters water. In addition, from the perspective of cost saving and battery capacity improvement, the thickness of the aluminum plastic film aluminum foil layer in existing power soft pack batteries is usually only 40 microns. The existing aluminum plastic film does not meet the long-term water corrosion requirements regardless of its composition and/or thickness. Due to the lack of water corrosion resistance, batteries packed in such aluminum plastic films are immersed in water for a long time and there is a risk of perforation.

In order to improve the hydrolysis resistance of the aluminum plastic film, a common method in the prior art is to improve the hydrolysis resistance of the outer protective film. For example, a PET film that is more resistant to water than a nylon film is used as the outermost protective film. After using PET film, the corrosion resistance to moisture or water droplets in the air is improved, but it is still not suitable for long-term soaking in water.

### SUMMARY

In order to obtain higher battery cooling performance, the present invention boldly adopts a cooling scheme in which a soft pack battery is directly immersed in cooling water. However, after further research, it is found that the outermost nylon protective layer in the existing aluminum plastic film for soft-pack battery packaging has poor corrosion resistance against antifreeze coolant. The aluminum foil as a water-blocking layer is an aluminum-iron alloy, and its mechanical strength and corrosion resistance are insufficient. Therefore, the existing aluminum plastic film cannot meet the requirements of long-term immersion water cooling system. In order to overcome the above drawbacks, the present invention provides creatively new battery packaging material solutions and battery cooling system solutions to meet the thermal management requirements for large-capacity battery systems such as new energy vehicles or energy storage applications.

Aiming at the defect that the anti-freezing liquid for aluminum plastic film used for packaging batteries in the prior art (referred to as antifreeze liquid, whose main component is ethylene glycol and water) or the anti-corrosion performance is insufficient, that is, it is easily perforated by corrosion. The present invention specifically provides an aluminum plastic composite film (hereinafter referred to as an aluminum plastic film) that can be used for lithium ion secondary battery packaging, and has a higher resistance to corrosion by a coolant.

A first aspect of the present invention provides a battery (preferably a soft pack battery) packaging material formed from a metal plastic composite film (preferably an aluminum plastic film), comprising a metal foil layer (preferably an aluminum foil layer) and a plastic layer laminated to the inner surface of the metal foil layer (preferably an aluminum foil layer).

According to a second aspect of the present invention, there is provided a soft-pack battery including an electrode material and an electrolyte and the above-mentioned metal-plastic composite film (preferably an aluminum plastic film) for external packaging. A plastic layer on the inner surface of the metal foil layer (preferably an aluminum foil layer) isolates the electrolyte from the metal foil layer (preferably an aluminum foil layer).

According to a third aspect of the present invention, there is provided a battery thermal control device, preferably a soft-pack battery thermal control device, including the above soft-pack battery. The soft pack battery can be packaged with the above-mentioned corrosion-resistant aluminum plastic film, and the soft pack battery is immersed in a coolant such as an antifreeze coolant. Preferably, the battery packaging material formed of the metal plastic composite film is immersed in the coolant, and more preferably, the metal foil layer (preferably an aluminum foil layer) is immersed in the coolant. This allows direct heat exchange with the coolant. In this way, the heat exchange effect of the battery is better, and the temperature of the battery is more uniform throughout.

A fourth aspect of the present invention is to provide a method for manufacturing a battery packaging material, preferably an aluminum plastic film, formed of the metal plastic composite film.

In a preferred embodiment of the present invention, the aluminum foil layer is a single layer, and more preferably, the aluminum foil layer is formed of a corrosion-resistant aluminum alloy. Wherein, the so-called “corrosion-resistant” refers to resistance to cooling water or antifreeze corrosion. Unless otherwise specified, in the present invention, the term “corrosion resistance” means resistance to cooling water or antifreeze, and not to resistance to electrolyte corrosion.

In a preferred embodiment of the present invention, the aluminum foil layer is a composite layer. The aluminum foil layer includes a core material and a skin material located on the outside of the core material. The corrosion potential of the skin material of the aluminum foil layer is lower than the corrosion potential of the core material. More preferably, the core material is located between the inner plastic layer and the skin material. More preferably, in the battery thermal control device, the skin material of the aluminum plastic film packaging the soft-pack battery is immersed in the coolant.

The aluminum plastic film of the present invention is a film composite material formed of a plastic film and an aluminum foil film, and is used as a packaging material for a polymer lithium battery.

Wherein, the aluminum foil layer has a plastic layer on one side, or both sides of the aluminum foil layer are compounded with a plastic layer. If the plastic layer is compounded on only one side of the aluminum foil layer, it is preferably compounded only on the inner side of the aluminum foil layer. Wherein, the above-mentioned scheme includes the following situation: The plastic layer compounded on one side surface of the aluminum foil layer can be either a single layer plastic or a multilayer plastic.

Further, the inner plastic layer is preferably a thermoplastic resin film, for example, polypropylene (PP) film or polyethylene (PE) film. Wherein, the thickness of the inner plastic layer may be 50-300 micrometers, preferably more than 60 less than 100 micrometers, and more preferably 70-90 micrometers. The inner plastic layer can also be referred to as a heat seal layer or a seal layer. Preferably, the inner plastic layer is a polyolefin resin or an acid-modified polyolefin resin. The inner plastic layer may also be blended with various additives such as flame retardants, lubricants, anti-blocking agents, antioxidants, light stabilizers, and tackifiers.

Preferably the inner plastic layer has better electrical insulation properties so that the withstand voltage value is higher, for example the withstand voltage is preferably greater than 1000V, more preferably greater than 2000V.

Further, the outer plastic layer is preferably a heat-resistant resin film. Examples include polyamide (PA) or nylon (Ny or ON) films, or polyester (PET) films, or polyimide (PI) films.

In addition, the composite layer aluminum alloy described above preferably includes at least a core material and a skin material composited on the outside of the core material. The composite layer aluminum alloy may be a two-layer aluminum alloy or a multi-layer aluminum alloy.

The above aluminum plastic film of the present invention may be any one of the structures including A)-B):

A) The aluminum plastic film has a laminated body composed of an inner plastic heat-seal layer, an intermediate aluminum foil layer, and an outer plastic protective layer, wherein the intermediate aluminum foil layer is formed of a composite layer aluminum foil having a sacrificial anode protection function. For example, the aluminum foil of the composite layer is formed of a core material and a skin material having a lower corrosion potential than the core material.

B) The aluminum plastic film has a laminated body composed of an inner plastic heat seal layer and an outer aluminum foil layer, wherein the outer aluminum foil layer is formed of a composite layer aluminum foil having a sacrificial anode protection function. The aluminum plastic film does not contain an outer plastic protective layer.

Wherein, the inner plastic heat seal layer may also be referred to as a thermoplastic resin film layer, and the outer plastic protective layer may also be referred to as a heat-resistant resin film layer.

The corrosion potential of the skin material in the composite layer aluminum foil is 5 mV-500 mV lower than the corrosion potential of the core material. Further, the corrosion potential of the skin material is 50 mV-500 mV lower than the corrosion potential of the core material. Preferably, the corrosion potential of the skin material is 70 mV-200 mV lower than the corrosion potential of the core material. More preferably, the corrosion potential of the skin material is 100 mV-170 mV lower than the corrosion potential of the core material.

In the present invention, unless otherwise specified, the corrosion potential refers to the corrosion potential in a water-based coolant environment. Through the reasonable potential matching between the skin material and the core material in this composite aluminum foil, it is beneficial to avoid the point corrosion of the aluminum foil (especially the core material).

Unless otherwise specified in the present invention, the coolant is a water-based coolant. The so-called water-based coolant refers to a coolant containing water as a basic component. The water-based coolant may also be an antifreeze containing various antifreeze agents (such as ethanol, ethylene glycol, propylene glycol, etc.) to form a freeze-proof function. Therefore, the coolant of the present invention includes the following types: pure water, a mixed liquid of ethylene glycol and water, and the like.

Alternatively, the aluminum plastic film includes an aluminum foil layer and a plastic layer compounded on the surface of the aluminum foil layer; wherein the aluminum foil layer is also covered with a metal zinc layer on the outside.

Further, the core material of the above composite aluminum foil layer is formed of a corrosion-resistant aluminum alloy or pure aluminum. The pure aluminum includes industrial pure aluminum and high-purity aluminum. The purity of aluminum in the pure aluminum is preferably ≥99.0%, more preferably 99.0% to 99.99%.

The corrosion-resistant aluminum alloy of the present invention means that the aluminum alloy and the aluminum plastic film can maintain normal functions without failure in the environment in direct contact with the coolant, such as the aluminum alloy is not corroded by the coolant. The “non-failure” mentioned above includes that the electrical insulation function of the aluminum plastic film does not fail and the barrier function does not fail. Although its performance is attenuated in quantity, it still meets basic requirements. The so-called “long-term” refers to the normal life cycle of a product (such as an automobile or a car battery), such as a life of more than 5 years, preferably more than 10 years, more preferably more than 15 years. The corrosion-resistant aluminum alloy of the present invention may be selected from the following rust-proof aluminum or aluminum alloys having good corrosion resistance: 1 series aluminum alloy, 3 series aluminum alloy, 5 series aluminum alloy and 6 series aluminum alloy. Since the corrosion-resistant aluminum alloy (such as aluminum-manganese alloy AA3003, etc., the following omitting AA) or pure aluminum has a good resistance to coolant corrosion, it can be used as an aluminum foil layer of aluminum plastic film. It can be used in applications where it is in direct contact with the coolant.

If the aluminum foil layer is a composite layer, the core material and the skin material are compositely formed, the core material is located inside, the skin material is located outside, and the corrosion potential of the skin material is lower (or negative) than the corrosion potential of the core material. When in contact with a corrosive medium, the composite layer aluminum foil forms electrochemical corrosion, and the skin material acts as a sacrificial anode, protecting the core material as a cathode, thereby ensuring that the aluminum foil layer in the aluminum plastic film can resist corrosion of the water-based coolant for a long period of time. This ensures the battery life. Wherein, the skin material may be a single layer material, or it may be a multilayer material. If the skin material is multilayered, it is preferred that the corrosion potential of the multilayer skin material decreases from the inside to the outside. The thickness of the skin material preferably accounts for 8 to 20% of the entire aluminum foil layer, more preferably 10±2%. The inside of the present invention refers to the side that is close to the electrolyte inside the cell when it is applied to a soft pack battery; the outside refers to the side that is far from the electrolyte inside the cell when it is applied to a soft pack battery.

Wherein, the core material may also be referred to as an aluminum substrate. The plastic layer may be a plastic layer of various mature applications in the prior art, such as a cast polypropylene film (CPP) in the inner layer and a nylon film (ON) or/and polyester film (PET) in the outer layer. Between the plastic layer and the aluminum foil layer, adhesive bonding or thermal compounding in an existing process may be used.

Further, the corrosion-resistant aluminum alloy is selected from aluminum-manganese aluminum alloy, aluminum-magnesium aluminum alloy, aluminum-magnesium-silicon aluminum alloy, or aluminum-silicon aluminum alloy. The corrosion-resistant aluminum alloy is more preferably aluminum-manganese aluminum alloy, or aluminum-magnesium aluminum alloy.

Alternatively, further, the corrosion-resistant aluminum alloy is selected from 3 series aluminum alloy, 1 series aluminum alloy, 5 series aluminum alloy, 6 series aluminum alloy, or 4 series aluminum alloy. Or these aluminum alloys have good corrosion resistance. The corrosion-resistant aluminum alloy is more preferably 3-series aluminum alloy, 1-series aluminum alloy, 5-series aluminum alloy, or 6-series aluminum alloy.

The aluminum alloy of the present invention is named according to the corresponding standards of the Aluminum Association of America.

Further, if the aluminum foil layer is a composite layer, the skin material of the aluminum foil layer is selected from aluminum zinc aluminum alloy, or aluminum copper aluminum alloy. The skin material of the aluminum foil layer is more preferably aluminum zinc aluminum alloy. The zinc element content in the aluminum-zinc alloy is preferably 1%-10%, more preferably 4%-7%.

Alternatively, further, if the aluminum foil layer is a composite layer, the skin material of the aluminum foil layer is selected from a 7-series aluminum alloy or a 2-series aluminum alloy. That is, the skin material is selected from aluminum alloys of 7 or 2 series aluminum alloys which have a lower corrosion potential than the core material, such as 7072 aluminum alloy or Al clad 2024 aluminum alloy. The skin material of the aluminum foil layer is more preferably a 7-series aluminum alloy. For example, the corrosion potential of 3003 aluminum alloy is approximately −0.72V, the corrosion potential of 7072 aluminum alloy is approximately −0.88V, and the corrosion potential of 2024 aluminum alloy is approximately −0.83V. Further, in addition to the basic 7072, the skin material can also use other modified 7072.

Alternatively, further, if the aluminum foil layer is a composite layer, the skin material of the aluminum foil layer is selected from a modified aluminum alloy to which zinc is added. Wherein, the skin material is preferably a zinc-added 1 series aluminum alloy or a zinc-added 3 series aluminum alloy, such as a 3003 aluminum alloy modified type in which 1.0%-2.5% of zinc is added. The zinc added 3003 has a potential drop of about −0.82 to −0.88 V, which is lower than the potential of the 3003 core material. Alternatively, the skin material is preferably an aluminum alloy formed by adding zinc to a 1 series aluminum alloy (pure aluminum), such as a 1050 aluminum alloy modified type in which a mass percentage of 4% to 7% of zinc is added.

Further, the corrosion-resistant aluminum alloy is preferably 3003 aluminum alloy, or 3004 aluminum alloy, or 3005 aluminum alloy, or 3105 aluminum alloy, or 3A21 aluminum alloy.

Further, pure aluminum is 1050 aluminum alloy, or 1060 aluminum alloy, or 1070 aluminum alloy, or 1100 aluminum alloy.

Further, if the aluminum foil layer is a composite layer, the skin material of the aluminum foil layer is 7072 aluminum alloy or 7075 aluminum alloy.

The aluminum foil of the present invention generally refers to a pure aluminum or aluminum alloy in the form of a film (or a thin sheet). Therefore, the aluminum foil of the present invention can also be referred to as an aluminum film. The thickness of the aluminum foil may be an aluminum film within 200 μm, and may alternatively be an aluminum film 200-300 μm or 300-500 μm thick. Alternatively, further, the thickness of the aluminum foil layer in the aluminum plastic film is preferably 80-500 μm. The thickness is more preferably 100-300 μm. The thickness is even more preferably 200-300 μm.

Alternatively, further, the thickness of the aluminum foil layer in the aluminum plastic film is 80-100 micrometers, or 100-150 micrometers, or 150-200 micrometers, or 200-300 micrometers, or 300-500 micrometers.

Further, the exterior of the aluminum foil layer is covered with a metallic zinc layer. The zinc layer is preferably formed by a zinc spray process.

Alternatively, further, the aluminum foil layer is a composite layer, the aluminum foil layer includes a core material and a skin material, the core material is an aluminum alloy, and the skin material is a metal zinc layer.

Further, the exterior of the aluminum foil layer is bonded to the plastic protective layer by a release agent. In this way, the plastic protective layer outside the aluminum foil layer can be easily separated.

Further, the heat seal layer material may be a polypropylene (PP) film or a polyethylene (PE) film.

Further, the material of the plastic protective layer may be a nylon (ON) film or a polyester (PET) film.

The above technical solution contains the following technical solutions:

If the aluminum foil layer of the aluminum plastic film is a single layer (non-composite layer), the aluminum foil layer may be a 3 series aluminum alloy, a 1 series aluminum alloy, a 5 series aluminum alloy, or a 6 series aluminum alloy.

If the aluminum foil layer of the aluminum plastic film is a composite layer, the core material of the aluminum foil layer may be a 3 series aluminum alloy, a 1 series aluminum alloy, a 5 series aluminum alloy, a 6 series aluminum alloy, or an 8 series aluminum alloy. And the skin material of the aluminum foil layer may be a 7-series aluminum alloy or a 2-series aluminum alloy.

The aluminum foil of the aluminum plastic film provided by the present invention has good corrosion resistance, and the aluminum foil layer and the aluminum plastic film containing the aluminum foil layer have long-term resistance to coolant corrosion.

The aluminum plastic film provided by the present invention, such as its aluminum foil layer adopts a 3 series aluminum alloy (e.g., 3003), and more preferably an aluminum alloy composite layer of a 3 series aluminum alloy and a 7 series aluminum alloy composite (e.g., 3003/7072), has excellent resistance to coolant corrosion, can be used in vehicle soft pack power battery system, and allows the soft plastic battery aluminum film and direct contact with the heat exchange.

The above-mentioned aluminum plastic film of the present invention can also be used for an aluminum plastic film for battery packaging, and the aluminum foil layer has a function of a water-blocking layer.

As an alternative, the inner side of the aluminum foil layer may further have an anti-corrosion treatment layer formed by chromate treatment or formed by rare earth oxide treatment, but it is not necessary. In the present invention, the aluminum plastic film containing only the inner plastic layer is immersed in the conductive coolant, and the aluminum foil layer is in electrical communication with the conductive coolant. In rare cases, when the electrolyte reaches the aluminum foil layer through the inner plastic layer, the electrolyte is in electrical communication with the aluminum foil layer, the conductive coolant, and the external ground wire. This in turn triggers an insulation resistance alarm so that corrosion of aluminum foil by hydrofluoric acid can be promptly detected and the risk of electrolyte leakage and the like can be prevented. Therefore, in the thermal management system of the present invention, the inside of the aluminum foil of the aluminum plastic film is not subjected to conventional anti-corrosion treatment, and the safety performance of the battery and the entire system can still be guaranteed.

The present invention provides an aluminum plastic film further having the following resistance to coolant corrosion. The corrosion resistance test method is an Oyama Water Solution corrosion test; the corrosion resistance life of the aluminum plastic film or its aluminum foil layer in the above test is more than 500 hours. Further, the aluminum plastic film or its aluminum foil layer has a corrosion life of more than 1000 hours. Further, the aluminum plastic film or its aluminum foil layer has a corrosion life of more than 2000 hours.

The thickness of the aluminum foil of the aluminum plastic film satisfying the requirements for the corrosion resistance of the OY aqueous solution in the present invention is preferably more than 80 μm, further preferably more than 100 μm, and still more preferably 120 μm to 300 μm.

Alternatively, the aluminum plastic film or its aluminum foil layer has the following resistance to coolant corrosion. OY aqueous corrosion test, or internal corrosion resistance test in the ASTM D2570 standard; the corrosion-resisting life of the aluminum plastic film or its aluminum foil layer in the above test is greater than 150 hours, or greater than 200 hours, or greater than 336 hours. Further, the corrosion-resisting life of the aluminum plastic film or its aluminum foil layer is more than 500 hours. Further, the aluminum plastic film or its aluminum foil layer has a corrosion-resistant life of more than 1000 hours. Further, the corrosion-resisting life of the aluminum plastic film or the aluminum foil layer thereof is greater than 2000 hours; further, the corrosion-resistant life of the aluminum plastic film or the aluminum foil layer thereof is greater than 2500 hours.

In the prior art, an 8-series aluminum (such as 8021 or 8079) foil having a thickness of 40 μm has a lifetime of about 98 hours in an OY aqueous solution corrosion test, which cannot satisfy the design life requirement of the vehicle at all, and therefore cannot meet the requirements of the antifreeze-immersed cooling method. Therefore, in order to have the above-mentioned corrosion resistance, the aluminum foil in the aluminum plastic film needs to have a suitable aluminum alloy material composition and/or a suitable thickness.

The aluminum foil material that satisfies the corrosion resistance requirements of the above coolant can be selected from the following materials: single-layer 1 series aluminum alloy (pure aluminum), single-layer 3 series aluminum alloy, or composite layer aluminum alloy with sacrificial anode protection function.

The thickness of the aluminum foil that satisfies the corrosion resistance requirements of the above coolant resistance can be selected from the following thicknesses: 80-120 micrometers, or 120-150 micrometers, or 150-200 micrometers, or 200-300 micrometers.

For example, the pure aluminum AA1050 with a thickness of more than 150 μm, or the composite aluminum alloy formed with a composite of AA1050 with a thickness of 100 μm and AA7072 with a thickness of 20 μm (that is, the total thickness of the aluminum alloy with a composite layer of 120 μm). The aluminum plastic film manufactured from the above two types of aluminum foil can meet the anti-freezing fluid corrosion life requirements described above, and thus can meet the automotive life requirements.

In addition to solving the above-described corrosion life-span problem from the perspective of aluminum foil, the present invention can also improve the water-resistant corrosion life of the aluminum plastic film from the outer plastic layer. Preferably, the outer plastic layer is a hydrolysis-resistant plastic layer. Further, the outer plastic layer is a Teflon layer, or a PE layer, or a composite material of a PE layer and a PA layer, or a water resistant improvement layer of the PA. Alternatively, if there is no plastic layer on the outside, that is, the aluminum foil is the outer layer material, an anticorrosive coating such as a chromate treatment or a rare earth oxide treatment may be applied to the outer surface of the aluminum foil layer.

Alternatively, as described from the perspective of the entire vehicle application, it is preferable that the lifetime of the coolant corrosion resistance of the aluminum plastic film or its aluminum foil is more than 5 years, preferably more than 10 years, and more preferably more than 15 years. The coolant is, for example, an antifreeze consisting mainly of ethylene glycol and water.

Unless otherwise specified in the present invention, the term “lifetime” means that the aluminum plastic film and its aluminum foil cannot be perforated during this lifetime. In order to obtain the above-mentioned corrosion resistance of the coolant, the aluminum foil in the aluminum plastic film needs to use the above-mentioned suitable aluminum alloy material and sufficient thickness. For example, the aluminum plastic film is preferably composed of an aluminum foil layer and a thermoplastic resin film compounded on the aluminum foil, wherein the aluminum foil is an aluminum foil having a sacrificial anode functional composite layer and preferably has a thickness of 100 to 300 μm. The existing aluminum plastic film products do not consider the application of soaking in antifreeze liquids, nor do they have the function of being immersed in the antifreeze liquid for a long time without failure; and the aluminum plastic film products of the present invention possess the above-mentioned special features.

Further, the aluminum plastic film or its aluminum foil also has deep drawability or moldability. In other words, the aluminum plastic film or its aluminum foil also has good deep drawability or moldability. Or that the aluminum plastic film also has good deep drawing formability. Or the aluminum plastic film or its aluminum foil also has a good cupping value at the same time. Because of its deep redness can be measured by the value of the cupping. For example, according to the GB/T 4156-2007 “Metal sheet and thin strip Erickson cupping test” standard test, the aluminum foil or aluminum plastic film aluminum foil stamping depth value or cupping value greater than 5 mm. It is preferably greater than 10 mm, more preferably greater than 12 mm. The so-called stamping depth value or cupping value means that the aluminum plastic film or its aluminum foil cannot be perforated after the punching or cupping test within this value.

Further, the present invention also provides an aluminum plastic film including an aluminum foil layer and a plastic layer compounded on the surface of the aluminum foil layer. The aluminum foil layer is a composite layer aluminum foil. The aluminum foil layer includes a core material and a skin material located on the outside of the core material. The corrosion potential of the skin material is lower than the corrosion potential of the core material. Wherein, the skin material located on the outside of the core material is formed by two layers of skin materials or more than two layers of multilayer skin materials, and the corrosion potential is reduced from the inside to the outside. This creates a surface corrosion gradient that is more conducive to pitting corrosion.

In order to form a potential gradient, it is also possible to allow the composite layer aluminum foil to be heated at a high temperature so that zinc in the skin material gradually diffuses toward the core material. Thus from the outside to the inside of the aluminum foil layer, the zinc content continuously changes, and the corrosion potential continuously changes. This avoids the occurrence of cliff-like changes in the zinc content and corrosion potential, which is more conducive to the transformation of corrosion morphology into uniform layer corrosion. The anti-corrosion mechanism of the composite layer aluminum foil is different from the traditional anti-corrosion coating methods such as the aluminum foil surface chrome. Composite layer aluminum foil itself is aluminum, which can improve the corrosion morphology by adjusting the corrosion potential of different layers inside the aluminum foil. That is, point corrosion transforms into layer corrosion, preventing perforation of the aluminum foil and failure of the battery. If the aluminum foil is immersed in the cooling water after the chromate treatment on the outer surface, although the corrosion rate of the aluminum foil can be reduced, the corrosion morphology of the aluminum foil cannot be improved; and the effect of suppressing the pitting corrosion is not significant.

It is worth noting that after the high-temperature diffusion process, the boundary between the layers of the above composite layer is not very clear, and the composition and potential between the layers are not step-like mutations, but a gradual process. Therefore, the composite layer aluminum foil according to the present invention includes both composite layers composed of different layers of different aluminum alloys before high temperature treatment, also included is a composite layer with a gradual change in element content or a gradual change in corrosion potential in the direction perpendicular to the aluminum foil surface after high temperature treatment.

The soft-pack battery thermal control device as described above further includes a coolant, and the outer package of the soft-pack battery is in direct contact with the coolant. Further, the coolant included in the battery thermal control device is water, a mixed liquid containing ethanol and water, a mixed liquid containing ethylene glycol and water, a mixed liquid containing propylene glycol and water, or other antifreeze coolant. These coolants are currently used in automobiles and industrially. They are not insulating type cooling media but are conductive coolants having conductive properties including weak electrical conductivity. However, compared to insulating cooling media such as silicone oil or transformer oil, the above-mentioned conductive coolant has advantages of high thermal conductivity, good fluidity, high thermal conductivity, and relatively low cost.

Based on the above, the present invention provides the following soft-pack battery thermal control device, which includes a soft-pack battery and a coolant. The outer package of the soft pack battery is in direct contact with the coolant, and the soft pack battery uses one or more of the above-mentioned soft pack batteries. Wherein, the coolant is a conductive coolant.

Further, the thermal control device further includes a main board and an outer shell. The main board and the outer shell form a sealed chamber. The electrodes of the soft pack battery protrude from the main board. The body of the soft pack battery is disposed in the sealed chamber.

Further, the thermal control device further includes a partition; at least part of the surface of the partition is in direct contact with at least part of the outer surface of the soft-pack battery, and a fluid passage is provided in the partition. A plurality of soft-pack batteries constitute a battery unit, and the battery units are spaced from the partition. The battery unit may be one, or two, or more soft-pack batteries. Wherein, the battery packaging material is preferably an aluminum plastic film. The partition is made of a metal material; the corrosion potential of the partition is equal to or less than the corrosion potential of the aluminum foil in the aluminum plastic film. Further, the partition is made of a metal material; the corrosion potential of the partition is negative to the corrosion potential of the aluminum foil in the aluminum plastic film; or the corrosion potential of the partition is equal to or less than the corrosion potential of the skin material of the aluminum foil in the aluminum plastic film. The partition serves as a support for the soft-pack battery and configures flow field. The partition may be an extruded flat tube, a straight fin, or a staggered serrated fin. In the present invention, the above fin is a type of partition, or a fin type partition having a fluid passage. These fin partitions mainly function to partition adjacent battery units so as to form flow channels, and support and fix the battery units. Therefore, the fin partition of the present invention does not include fins such as pin fins that cannot support the battery unit. The battery units are closely spaced from the fin partitions, forming a unitary body, and the entire body can be fastened together using straps or through bolts, so that the thermal control system and the battery units have a reliable vibration resistance.

Further, the aluminum plastic film seals the periphery of the battery core, and only a battery electrode or an electrode connection port protrudes from the aluminum plastic film. The battery thermal control device further includes a main board. The main board is provided with a socket. A portion of the battery protruding from the aluminum film is inserted into the main board through the socket.

Further, the battery thermal control device further includes an outer shell. The interior of the outer shell body is provided with an accommodation chamber, and the battery unit and the spacer are both placed in the accommodation chamber of the outer shell body, and the outer shell body further includes a fluid inlet and a fluid outlet.

Further, the main board is located in the accommodating chamber of the outer housing and divides the accommodating chamber into two parts. The first portion houses the battery unit body and the partition, the second portion receives the electrode and/or electrode connection port portion protruding from the aluminum film, and the first portion and the second portion are physically isolated.

The battery thermal control device of the present invention may further include a cooling pump, a coolant heat exchanger, and a corresponding water pipe. Alternatively, the present invention provides a battery cooling system that employs the above-described battery thermal control device, and further includes a cooling pump, a coolant heat exchanger, and a corresponding water pipe. Wherein, the coolant heat exchanger is a gas-liquid heat exchanger that directly exchanges heat with the ambient air.

The heat exchange efficiency of the battery in the above-mentioned battery thermal control device is very high, the heat transfer resistance between the battery body and the coolant is very low, and the heat exchange temperature difference is very small. Therefore, the temperature of the coolant can be allowed to be higher under the premise that the substances in the battery body (such as the electrolyte, the separator, and the solid electrolyte interface film SEI) are not overheated. That is, the requirement for external cooling of the battery is reduced, and the cooling cost is reduced, so that the above-described gas-liquid heat exchanger can be used. Further, the above cooling system may further include an electric heater for heating the battery.

In the aluminum plastic film and the soft-pack battery that are resistant to coolant corrosion as described above, the aluminum foil layer initially comes into contact with the coolant as a water-contact layer. Or after the outer protective layer (such as a nylon film) is peeled off, it is contacted with the coolant as a contact layer.

The present invention provides another battery packaging material which is composed of a metal foil and a thermoplastic resin film located inside the metal foil. Alternatively, the battery packaging material is a composite of a thermoplastic resin film, a metal foil, and a heat-resistant resin film, and the metal foil is located between the thermoplastic resin film and the heat-resistant resin film. Wherein, the metal foil is a single-layer metal having corrosion resistance, or the metal foil includes a core material and a skin material located outside the core material, and the corrosion potential of the skin material of the metal foil is lower than the corrosion potential of the core material. The metal foil is preferably an aluminum foil and/or a copper foil and/or a stainless steel foil. The thickness of the metal foil is preferably 20 to 50 microns, or 50 to 80 microns, or 80 to 150 microns, or 150 to 200 microns, or 200 to 300 microns. Preferably, the outer side of the metal foil does not contain a plastic film, ie, the plastic film only composites on the inner side of the metal foil.

As an alternative, the metal foil layer may further include an anti-corrosion treatment layer on the inner side thereof, and the anti-corrosion treatment layer is formed by chromate treatment or formed by rare earth oxide treatment.

From another point of view, the present invention also provides the following solution for a soft-pack battery, namely, a soft-pack battery, which is packaged with an aluminum plastic film, and the soft-pack battery body has the following resistance to corrosion by a coolant:

Corrosion resistance test method: OY aqueous solution corrosion test;
The body of the soft-pack battery is immersed in a coolant, and the soft-pack battery has a corrosion resistant life of more than 500 hours in the above test.

Further, the corrosion-resistant life of the soft-pack battery body is greater than 1000 hours. Further, the corrosion-resistant life of the soft-pack battery body is greater than 2000 hours.

Alternatively, the above corrosion resistance test method is an internal corrosion resistance test in the ASTM D2570 standard, or the evaluation of its outer packaging aluminum foil is performed using a method similar to the QC/T 468-2010 standard in Section 5.14 “Internal corrosion performance test”.

The OY water solution (Oyama Water Solution) corrosion test referred to in the present invention is a general OY aqueous solution corrosion test of heat exchanger aluminum heat transmission industry.

The method for manufacturing an aluminum plastic film according to the present invention includes: first selecting the corresponding aluminum foil through the following corrosion resistance test, and then compounding the aluminum foil and the plastic film to form an aluminum plastic film. Wherein, the corrosion resistance test is an OY aqueous solution corrosion test, and the corrosion life of the aluminum foil under the corrosion test method is more than 500 hours.

The corrosion life is preferably greater than 1000 hours. More preferably it is more than 2000 hours. The aluminum foil may be selected from the above pure aluminum or aluminum alloy.

One of the more preferable solutions in the multiple technical solutions provided by the present invention is that the aluminum foil of the aluminum plastic film has a thermoplastic plastic film only inside; that is, the outer side of the aluminum foil does not contain a heat-resistant plastic film or a protective film. Compared with the traditional aluminum plastic film, the present invention improves the corrosion resistance and mechanical strength of the aluminum foil in the aluminum plastic film; and the aluminum plastic film without the plastic film on the outer side is not only durable and reliable but also has a simpler process and lower cost. When the aluminum plastic film is in contact with the cooling water, the heat exchange efficiency is higher. More importantly, the above aluminum plastic film of the present invention also has new functions. That is, it has long-term cooling water corrosion resistance, so it can be immersed in the cooling water for a long time without failure, thus meeting the thermal management requirements of the immersed water-cooled soft pack battery cooling system, and providing a reliable guarantee for the performance improvement of the battery system.

In a plurality of technical solutions provided by the present invention, another more preferable solution is that the aluminum foil of the aluminum plastic film adopts a composite layer aluminum foil, and the layers of the composite aluminum foil are matched with different corrosion potentials. As a result, the corroded form of the aluminum foil tends to be more lamellar, and the perforation of the aluminum foil due to corrosion is better avoided.

Different from other composite layer aluminum foils, one of the more preferable solutions of the aluminum foil in the present invention is that it is formed by compounding a core material made of pure aluminum and a skin material that is zinc-added on the basis of pure aluminum. The composite layer aluminum foil not only has excellent anti-cooling water pitting performance, but also has good moldability and packageability.

The aluminum plastic film provided by the present invention can also be a technical solution formed by the combination of the above technical features. The aluminum plastic film can be used for the packaging of a soft-pack battery directly in contact with cooling water, and has the advantages of corrosion resistance to cooling water and long service life.

### DESCRIPTION OF THE DRAWINGS

FIG. 1 is a schematic view of the structure of the first aluminum plastic film;

FIG. 2 is a schematic structural view of a second aluminum plastic film;

FIG. 3 is a schematic view of an application of a battery using the aluminum plastic film of the present invention;

FIG. 4 is a schematic diagram of a soft pack battery;

FIG. 5 is a schematic diagram of a soft-pack battery thermal control device;

FIG. 6 is a schematic view of a third structure of aluminum plastic film;

FIG. 7 shows the comparison of corrosion resistance of single-layer aluminum alloy (left) and composite-layer aluminum alloy (right);

FIG. 8 shows fin partitions in the form of staggered serrated fins. The fin partition includes a plurality of tooth-shaped units, and the same row of tooth-shaped units communicate with each other to form a fluid passage, and the adjacent tooth-shaped units are staggered one after the other. The top and bottom planes of the toothed units are in direct contact with the battery.

FIG. 9 is a fin partition in the form of a straight fin. It includes parallel risers and upper and lower plates connected to both ends of the risers. The plate is in direct contact with the battery, and fluid channels are formed between the risers.

### DESCRIPTION OF EMBODIMENTS

The present invention will be further described below with reference to specific embodiments. The scope of protection of the present invention includes but is not limited thereto.

### Embodiment 1

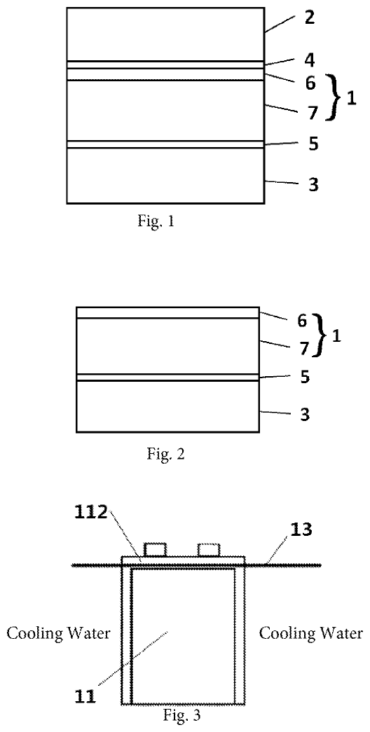

As shown in FIG. 1, an aluminum plastic film is provided. The aluminum plastic film includes an aluminum foil layer 1 and plastic layers 2 and 3 laminated on both surfaces of the aluminum foil layer. Wherein, the aluminum foil layer 1 is formed by compounding a 3 series aluminum alloy aluminum foil layer 7 (core material) and a 7 series aluminum alloy aluminum foil layer 6 (skin material). For example, a 3003 aluminum alloy and a 7072 aluminum alloy composite are used, and a 7072 aluminum alloy layer 6 is composited on the outside of the 3003 aluminum alloy layer 7. Alternatively, the aluminum plastic film is formed by sequentially stacking a heat seal layer, a 3003 aluminum foil layer, a 7072 aluminum foil layer, and a nylon layer, wherein the aluminum foil layer and the plastic layer are adhered with a conventional adhesive. In other words, the aluminum plastic film is composed of a heat seal layer, an adhesive layer, a 3003 aluminum foil core layer, a 7072 aluminum foil skin layer, an adhesive layer, and a nylon protective layer.

The corrosion potential of the 3003 aluminum alloy is approximately −0.72V, and the corrosion potential of the 7072 aluminum alloy is approximately −0.88V. Since the corrosion potential of the 7072 aluminum alloy is lower than the corrosion potential of the 3003 aluminum alloy, the 7072 aluminum alloy acts as a sacrificial anode and protects the core material from corrosion when in contact with the coolant. The thickness of the heat seal layer is preferably 80-100 μm, the thickness of the nylon protective layer is preferably 20-30 μm, and the thickness of the composite aluminum foil layer is preferably 200-300 μm. Wherein, the thickness of the 7-series aluminum alloy layer 6 preferably accounts for 10% of the entire aluminum foil layer 1. Similarly, the adhesive between the inner and outer plastic layers 2 and 3 and the aluminum foil layer 1 is bonded by the adhesive 4 and 5, respectively.

In addition, the state of the heat treatment of the aluminum foil layer may be O state, H14 state, or H16 state, among which O state is preferable.

The aluminum foil layer in this embodiment is thicker than the aluminum foil layer in the conventional aluminum plastic film, which is not only favorable for long-term resistance to the corrosion of the antifreeze but also is favorable for the vapor barrier property of the aluminum plastic film, thereby ensuring the long-term reliability of the soft packet battery packaging.

### Embodiment 2

The structure of the present embodiment is substantially similar to that of Embodiment 1, and the aluminum alloy layer 1 is also formed by the composite of the core material 7 and the skin material 6, and the skin material 6 is an anode protection layer. In contrast, the 7023 aluminum alloy is replaced with a zinc-added 3003 aluminum alloy (3003+1% Zn or 3003+1.5% Zn in the following table) as a sacrificial anode layer. The potential of 3003+1% Zn is about −0.83V to −0.89V, and the potential is lower than that of the 3003 core material.

TABLE 1
Alloy Chemical Composition

| | chemical composition % | | | | | | other | | |
|---|---|---|---|---|---|---|---|---|---|
| Alloy | Si | Fe | Cu | Mn | Zn | Zr | single | total | the rest |
| 3003 | ≤0.6 | ≤0.7 | 0.05-0.2 | 1.0-1.5 | ≤0.1 | / | ≤0.05 | ≤0.15 | Al |
| 3003 + | ≤0.6 | ≤0.7 | 0.05-0.2 | 1.0-1.5 | 0.5-1.5 | / | ≤0.05 | ≤0.15 | Al |
| 1% Zn | | | | | | | | | |
| 3003 + | ≤0.6 | ≤0.7 | 0.05-0.2 | 1.0-1.5 | 1.0-2.0 | / | ≤0.05 | ≤0.15 | Al |
| 1.5% Zn | | | | | | | | | |

### Embodiment 3

A second type of aluminum plastic film is provided as shown in FIG. 2. The aluminum plastic film includes an aluminum foil layer 1 and a thermoplastic resin film layer 3 integrated inside the aluminum foil layer. The aluminum foil layer is a composite layer aluminum foil. The aluminum foil layer includes a core material and a skin material located on the outside of the core material. The corrosion potential of the skin material of the aluminum foil layer is lower than the corrosion potential of the core material. Further, the core material of the aluminum foil layer is formed of a corrosion-resistant aluminum alloy or pure aluminum. For example, the composite aluminum foil layer 1 is formed by compounding a 3-series aluminum foil layer 7 (e.g., 3003) and a 7-series aluminum foil layer 6 (e.g., 7072). The thermoplastic resin film layer 3 (also called the heat seal layer 3, such as CPP) is laminated only on the inner side of the aluminum foil layer 1, without the need for an outer nylon protective layer.

The thickness of the heat seal layer 3 (CPP) is preferably 30-50 μm, and the thickness of the entire composite aluminum foil layer 1 is preferably 200 μm. Wherein, the 7-series aluminum alloy layer 6 is compounded on the outside as a sacrificial anode; the thickness of the 7-series aluminum alloy preferably accounts for 10% of the entire aluminum foil layer 1. When used as a soft-pack battery packing material and the battery is immersed in cooling water, the 7-series aluminum alloy acts as a water-contact layer. Similarly, the inner thermoplastic resin film layer 3 and the aluminum foil layer 1 are adhesively bonded by an adhesive 5 commonly used for aluminum plastic films. The soft pack battery made of the aluminum plastic film provided above can be immersed in the coolant for a long time, and has a long-term resistance to the corrosion of the coolant.

### Embodiment 4

The structure of this embodiment is substantially similar to that of embodiment 3, and 3003 aluminum alloy is also used for the core material layer. The difference is that the skin material is changed from a 7-series aluminum foil layer to a metal zinc layer, and the thickness of the metal zinc layer may preferably be 10-20 μm, which may be formed by a zinc spray process. Since the potential of this metal zinc is lower than that of the aluminum alloy core material, it can be used as a sacrificial anode to protect the core material from corrosion. And zinc metal can effectively prevent aluminum alloy core pitting corrosion.

### Embodiment 5

This embodiment describes a battery using the above-mentioned aluminum plastic film and an application mode of the battery. A soft-pack battery is provided which comprises an electrode material and a polymer electrolyte and an aluminum plastic film for external packaging. Wherein, the soft-pack battery is covered with an aluminum plastic film containing a composite layer aluminum foil with a sacrificial anode function, such as the composite layer aluminum foil in embodiment 1 or 3, that is, the aluminum foil uses a 3003 aluminum alloy as core material and is externally compounded with a 7072 aluminum alloy as skin material. After the soft pack battery is packaged with the above aluminum plastic film that is resistant to corrosion by the antifreeze coolant, the soft pack battery may be soaked in the antifreeze coolant so that it can directly exchange heat with the antifreeze coolant. As shown in FIG. 3, after the soft pack battery 11 is sealed with the main board 13 through the top edge 112, the body of the soft pack battery 11 is immersed in the antifreeze coolant. In this way, the heat exchange effect of the battery is better, and the temperatures in the upper and lower parts of the battery are more uniform.

### Embodiment 6

This embodiment adopts an aluminum plastic film structure similar to that of Embodiment 1, except that the adhesive for bonding the nylon protective layer is a release agent that facilitates separation. That is, the nylon protective layer is similar to the release film. In this way, the nylon layer can protect the aluminum foil layer during the deep drawing process of the aluminum plastic film; after deep drawing, the nylon layer can be easily separated from the aluminum foil layer, thereby forming an aluminum plastic film similar to that in Embodiment 3.

### Embodiment 7

The aluminum plastic film described in this embodiment is formed by compounding a thermoplastic resin film (ie, a heat seal layer such as polypropylene) and a composite layer aluminum alloy foil. The core material layer 7 of the aluminum foil layer uses AA1050 pure aluminum, and the skin material 6 is formed of an aluminum alloy to which 4%-7% zinc element is added based on pure aluminum 1050 (simplified as AA1050+4-7% Zn). The corrosion potential of the skin material is negative to the core material, and the skin material is used as a sacrificial anode protection core material, and the skin material composite ratio is preferably 10±2%. The heat treatment state of the composite layer aluminum foil is an annealed state (O state), and the thickness is preferably 100-300 μm, more preferably 200-300 μm. The composite layer aluminum foil not only has excellent resistance to coolant corrosion, but also has good ductility and deep drawing performance.

The aluminum plastic film or its aluminum foil is required to have better ductility and deep drawing performance. According to the standard test of GB/T 4156-2007 Metallic Sheets and Thin-Band Erickson Cupping Tests, the cupping value of the aluminum plastic film or its aluminum foil is preferably more than 5 mm, more preferably more than 10 mm.

The aluminum plastic film or its aluminum foil is required to have better resistance to coolant corrosion. Corrosion resistance test method uses the OY water solution corrosion test commonly used in the aluminum heat transmission industry of heat exchangers. The specific test method may also refer to the corrosion test of the OY aqueous solution in Embodiment 1 of CN201080021209.6. The OY water corrosion test is roughly as follows:

OY aqueous solution components: chloride ion (CD: 195±1 mg/L, sulfate ion (SO₄²⁻): 60±0.2 mg/L, iron ion (Fe³⁺): 30±0.1 mg/L, copper ion (Cu²⁺): 1±0.01 mg/L. The pH of the OY aqueous solution is about 3 (the pH of the aqueous solution in the OY test described in the present invention is about 3 unless otherwise specified).

OY aqueous solution temperature: 88° C., stirring at 0.6-0.9 m/s (200 rpm) for 8 hours, then standing for 16 hours; the above cycle is repeated.

In the above OY aqueous solution corrosion test, any perforation near 5 mm of the edge of the aluminum foil is ignored. When corrosion piercing occurs at any point except the edge 5 mm in the aluminum foil, the accumulated corrosion test time is the corrosion life of the aluminum foil in the OY aqueous solution. Experiments show that the corrosion resistance life of the aluminum foil in the embodiment of the present invention is greater than 1000 hours.

Above, the corrosion life of aluminum plastic film or its aluminum foil can also be evaluated by its anti-corrosion service life when it is immersed in antifreeze on a real car, such as aluminum plastic film that has a service life of more than 5 years. It is preferably more than 10 years, more preferably more than 15 years.

### Embodiment 8

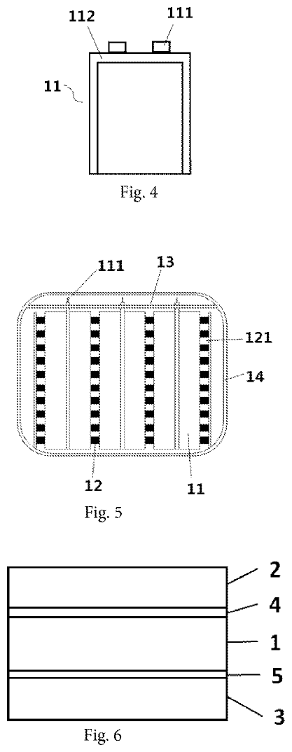

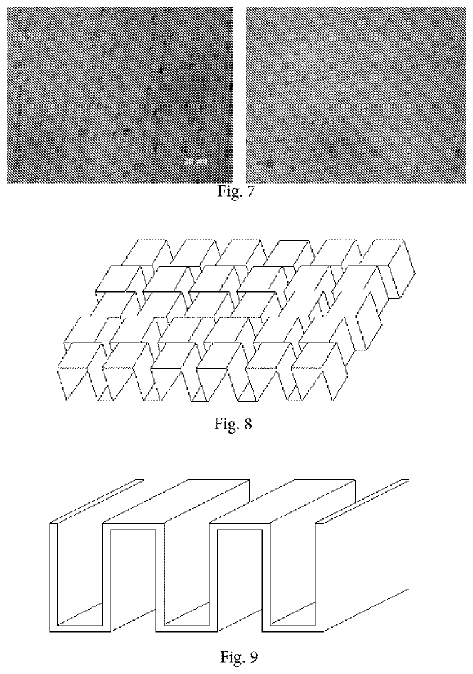

As shown in FIG. 4 and FIG. 5, the battery thermal control device described in this embodiment employs the above soft pack battery that can be directly immersed in a coolant (such as a coolant mainly composed of ethylene glycol and water) for a long period of time. The soft-pack battery thermal control device includes a soft-pack battery 11 and a water-based coolant. The outer package of the soft-pack battery 11 is in direct contact with a coolant, and the soft-pack battery 11 is packaged by any of the above-mentioned packaging materials resisted by a coolant (such as aluminum plastic film that is resistant to water-based coolant corrosion). The thermal control device also includes a partition 12 that is preferably a staggered saw-tooth fin partition as shown in FIG. 8, or a flat fin partition as shown in FIG. 9. At least part of the surface of the partition 12 is in direct contact with at least part of the outer surface of the soft-pack battery 11. In addition, a fluid passage 121 is provided in the partition 12. The fluid channel 121 is in direct contact with the battery 11, and the cooling water in the fluid channel 121 is in direct contact with the battery 11 for heat exchange. A soft pack battery 11 constitutes one battery unit (of course, two soft pack batteries can also be used to form one battery unit), and the battery unit is spaced from the partition 12. The partition serves as a support for the soft pack battery on the one hand and as forming coolant flow field on the other.

The aluminum plastic film seals the periphery of the battery core, and only the battery electrode or the electrode connection port protrudes from the aluminum plastic film. The battery thermal control device further includes a main board 13, and the main board 13 is provided with a socket. A portion of the battery protruding from the aluminum film (ie, positive and negative electrode tabs 111) is inserted into the main board 13 through the socket. Preferably, part of the top edge 112 of the battery is also inserted into the main board 13 through the socket.

The battery thermal control device also includes an outer housing 14. The interior of the outer housing 14 is provided with an accommodating chamber, and a plurality of the battery units and the partition 12 are integrated into the accommodating chamber of the outer housing 14. The outer housing 14 also includes a fluid inlet and a fluid outlet (not shown in the drawings).

The main board 13 is located in the accommodation chamber of the outer housing 14, and separates the accommodation chamber into two parts. The first portion houses the battery unit body and the partition 12, and the second portion receives the electrode and/or electrode connection port portion protruding from the aluminum plastic film. The physical isolation is between the first part and the second part.

The battery thermal control device also includes a coolant. The coolant is water, a mixed liquid containing ethylene glycol and water, a mixed liquid containing propylene glycol and water, or an antifreeze coolant.

Preferably, the partition 12 is made of a metal material, and the corrosion potential of the partition 12 is negative to the corrosion potential of the aluminum foil in the aluminum plastic film. For example, AA1050 aluminum alloy is used as the packaging material metal foil, and AA1050+5% Zn is used as the partition 12. Alternatively, the corrosion potential of the partition 12 is lower than that of the aluminum foil of the aluminum plastic film. For example, the packaging material metal foil is AA1050/AA1050+5% Zn alloy, and the partition 12 is AA1050+7% Zn. In this way, the partition can also play an anodic protective function, further preventing the battery from corroding and failing.

### Embodiment 9

This embodiment is the same as the aluminum foil used in Embodiment 7. The difference is that aluminum foil and aluminum plastic film excellent in molding property (or deep drawing property) are evaluated and selected as follows.

Follow the steps A-F below to perform the molding performance test and evaluation:

A, Teflon core material, mold size 34 mm×44 mm, rounded R=0.6 mm. According to the test requirements, adjust the forming depth of the press forming tester to a value between 5.0 mm and 15.0 mm. Adjust the compressed air pressure so that the mold side pressure is greater than or equal to 3.0 MPa.

B, take the surface smooth, clean, no wrinkle sample film, cut a width of not less than 100 mm, a length of not less than 200 mm film for testing.

C. Place the CPP surface of the film toward the core and place it in the press-molding tester. Ensure that the film is smooth and wrinkle-free, and the amount of side lamination film is sufficient.

D. Press the button to perform stamping. Carefully remove the sample after the stamping is complete.

E. Combining the CPP surface of the stamped sample with the CPP surface of the unpressed molded sample. Ensure that the sample is flat and free of distortion. Heat sealing is carried out along the edge of the stamping molding not more than 2 mm. The heat sealing conditions were: heat sealing temperature of 190° C. (uniform heating up and down), heat sealing pressure of 0.2 MPa, and heat sealing time of 6 seconds.

F. Visually inspect the stamped sample after heat sealing to check whether the sample has cracked or delaminated.

As can be seen from the above method, the depth of molding of the aluminum plastic film of the present invention is greater than 5.0 mm. More preferably, an aluminum plastic film or aluminum foil having a forming depth greater than 10.0 mm is selected.

### Embodiment 10

This embodiment is the same as the aluminum foil used in Embodiment 7. The difference is that instead of using the OY test to evaluate, the corrosion life of aluminum foils for aluminum plastic film is evaluated using the “Internal Corrosion Performance Test” in Section 5.14 of the QC/T 468-2010 standard.

Wherein, the corrosion resistance test in section 5.14 of the QC/T 468 standard is roughly as follows:

Test temperature: 88° C.

Mixed solution flow: 1.3-1.6 L/s (liters per second)

Mixture:

Antifreeze model: 45% ethylene glycol antifreeze, freezing temperature: −30° C.

ASTM water: 1 L (liter) of distilled water contains 148 mg (milligrams) of sodium sulfide, 165 mg of sodium chloride, and 138 mg of sodium bicarbonate.

Mixing ratio: 40% antifreeze+60% ASTM water.

The experimental results show that the corrosion life of the aluminum foil of the present invention is greater than 1000 hours.

### Embodiment 11

The core and skin materials of the composite layer aluminum alloy can be selected from the following Table 2 options 1 to 4:

| | | Core |
|---|---|---|
| Options | Skin material composition (weight percentage) | material |
| Option1 | Zn (4~7%) + Si (0.5~1.0%) + Ti (0.1~0.2%) + | AA1050 |
| | Fe (0.5~1.5%) + Al (the rest) | |
| Option2 | Zn (4~7%) + Si (0.5~1.0%) + Ti (0.1~0.2%) + | |
| | Fe (0.5~1.5%) + Sm (0.1~0.3%) + Al (the rest) | |
| Option3 | Zn (4~7%) + Si (0.5~1.0%) + Ti (0.1~0.2%) + | AA1050 + Sm |
| | Fe (0.5~1.5%) + Al (the rest) | (0.1%~0.3% |
| Option4 | Zn (4~7%) + Si (0.5~1.0%) + Ti (0.1~0.2%) + | weight |
| | Fe (0.5~1.5%) + Sm (0.1~0.3%) + Al (the rest) | percentage) |

Using the method of Embodiment 7, the corrosion life of the aluminum foil of the present embodiment is more than 1000 hours, and even more than 1500 or 2000 hours.

### Embodiment 12

This embodiment provides an aluminum plastic film comprising an aluminum foil layer and a plastic layer laminated on the surface of the aluminum foil layer. The aluminum foil layer is a composite layer aluminum foil. The aluminum foil layer includes a core material and a skin material located on the outside of the core material. The corrosion potential of the skin material of the aluminum foil layer is lower than the corrosion potential of the core material. Wherein, the skin material located on the outside of the core material is formed by two layers of skin materials or more than two layers of multilayer skin materials, and the corrosion potential is reduced from the inside to the outside.

For example, the aluminum foil layer from the inside to the outside is the core material, the first layer of skin material, the second layer of skin material. The core material is AA1050 aluminum alloy. The first skin material is AA1050 plus 2% Zn aluminum alloy, and the second skin material is AA1050 plus 4% Zn aluminum alloy. Therefore, the corrosion potential is: core material>first skin material>second skin material. This can further ensure that the corrosion is lamellar corrosion, thereby further avoiding pitting corrosion and ensuring battery safety.

### Embodiment 13

This embodiment provides another corrosion-resistance test of the aluminum plastic film aluminum foil of the soft-packaged battery outer package, that is, the anti-freezing solution corrosion test method of the soft-packaged battery. This test method is used to evaluate and determine the anti-freeze fluid corrosion life of the product.

Bodies of several identical soft-pack batteries are immersed in the following mixed solution. The positive and negative poles of the soft pack battery are vertically upwards, and the immersion height of the mixed solution is flush with the lower edge of the top edge of the soft pack battery.

Mixed solution composition: Consisting of 40% volume ratio antifreeze and 60% ASTM solution. The antifreeze is 45% ethylene glycol antifreeze, and the freezing temperature is minus 30 degrees Celsius; the ASTM solution consists of 1 liter of distilled water and 148 milligrams of sodium sulfate, 165 milligrams of sodium chloride and 138 milligrams of sodium bicarbonate.

Mixed solution temperature: 90±2 degrees Celsius. The mixed solution flows in a horizontal direction parallel to the largest surface of the battery body, and the flow rate through the surface of the battery body is 0.5 m/s.

The test is run at the above temperature and flow rate for 76 hours, and the standstill is allowed to stand for 8 hours as one cycle. Solution pH check and rehydration during shutdown. Solution check includes pH check and visual inspection. No pH change of ±1 is allowed during the test. The appearance of the solution does not allow turbidity and sedimentation.

The corrosion depth of the aluminum foil in the aluminum plastic film can be checked at any time during the test. The corrosion depth value of all corrosion points is counted. If the maximum value is greater than 10% of the original thickness of the aluminum foil, the moment when the maximum reaches 10% of the original thickness of the foil is recorded. The accumulated test time is defined as the corrosion life of the aluminum foil in the aluminum plastic film, that is, the corrosion life resistance of the anti-freeze liquid of the soft-pack battery. Therefore, the so-called lifetime in the test method of the present embodiment is the accumulated test time to reach the above-mentioned corrosion depth value.

In the above tests, the above description of the present invention shall prevail in different places. Other places may refer to the Chinese automobile industry standard QC/T 468-2010. It should be noted that the aluminum plastic film of the outer package of the soft-pack battery of the present invention is preferably an aluminum plastic film composed of aluminum foil and a thermoplastic resin film compounded on the inside of the aluminum foil. The outer side of the aluminum foil is free of other plastic layers. Therefore, the aluminum foil is in direct contact with the antifreeze solution at the beginning. However, the aluminum plastic film for the outer package of the soft-pack battery of the present invention may also be (although not preferred) an aluminum plastic film composed of an aluminum foil, a thermoplastic resin film laminated on the inner side of the aluminum foil, and a heat-resistant resin film laminated on the outer side of the aluminum foil. A typical heat-resistant resin film (such as PA or PET) is easily swollen by antifreeze. Therefore, in order to harmonize the test standards, the heat-resistant resin film outside the aluminum plastic film is peeled off before performing the above-described corrosion life test, and then the above corrosion test is performed.

For the convenience of brief description, the present invention defines the corrosion resistance test of the aluminum foil in the above-mentioned aluminum plastic film as the “specific antifreeze corrosion life test for a soft-pack battery”.

In order to meet the automotive durability requirements of the components, select those soft pack batteries that have a lifetime value greater than 336 hours in the specific antifreeze corrosion life test for a soft-pack battery. Since the power battery is very demanding on safety, a soft pack battery of more than 500 hours is preferable, and a soft pack battery of more than 1000 hours is more preferable; further, it is preferably a soft pack battery of more than 2000 hours. Still further preferred is a soft pack battery that is greater than 5000 hours.

As another assessment method is provided as follows, in the above “specific antifreeze corrosion life test for a soft-pack battery”, the test time is fixed at 14 days (ie, 336 hours). Check the depth of pitting everywhere, where the maximum pitting depth requirement is less than 50% of the original foil thickness. It is preferably less than 20%, more preferably less than 10%; further preferably less than 8%; and even more preferably less than 5%. In other words, the maximum pitting depth is 20% to 50% of the original thickness of the aluminum foil, or more than 10% and less than 20%, or more than 0% and less than 10%.

In order to have the above-mentioned corrosion resistance, the aluminum foil in the aluminum plastic film needs to have a suitable aluminum alloy material composition and a suitable thickness.

The aluminum foil material that satisfies the above corrosion resistance requirements can be selected from the following materials: single-layered 1 series aluminum alloy (pure aluminum), or composite layer aluminum alloy with sacrificial anode protection.

The thickness of the aluminum foil that satisfies the above requirements for corrosion resistance can be selected from the following thicknesses: 120-300 microns.

For example, a pure aluminum AA1050 with a thickness of more than 150 μm, or a composite aluminum alloy with a thickness of 100 μm of AA1050 and 20 μm of AA7072 (ie, a composite layer aluminum alloy with a total thickness of 120 μm). The use of the above two kinds of aluminum foils for the manufacture of aluminum plastic film and soft pack battery can meet the anti-freezing fluid corrosion life requirements above, so as to meet the automotive life requirements.

### Embodiment 14

This embodiment describes an aluminum plastic film in which aluminum foil is compositely formed of a core material and an outer skin material, wherein, the core material is formed of an 8-series aluminum alloy (such as 8079 or 8021) of 100 micrometers to 300 micrometers. The outer skin material is formed by adding 2%-6% by mass of zinc element on the basis of the 8 series aluminum alloy (as described in Table 3 below). The composite rate is 10%-20%. The aluminum plastic film containing this composite aluminum alloy has good corrosion resistance and deep drawability. When tested according to the method of Embodiment 7, the corrosion resistant life is greater than 1300 hours.

TABLE 3

| element | Si | Fe | Cu | Zn | Al | the other |
|---|---|---|---|---|---|---|
| Mass | 0.05-0.30 | 0.70-1.3 | ≤0.05 | 2.0-6.0 | the rest | ≤0.15 |
| percentage | | | | | | |

### Embodiment 15

This embodiment describes an aluminum plastic film in which aluminum foil is compositely formed of a core material and an outer skin material. The core material is formed of a 1-series aluminum alloy (such as 1050) of 100 μm to 300 μm. The outer skin material is formed by adding 2%-6% by mass of zinc element on the basis of the 1 series aluminum alloy (as described in Table 4). The composite rate is 10%-20%.

### Embodiment 16

The core material is formed of a 1-series aluminum alloy (e.g., 1050) of 100 μm to 300 μm, and the outer skin material is formed by adding 2%-6% by weight of zinc element on the basis of the 1 Series aluminum alloy (as shown in Table 4). The aluminum plastic film containing this composite aluminum alloy has a good resistance to electrolyte corrosion and good resistance to cooling water corrosion. Tested according to the method of Embodiment 7, its corrosion life is greater than 1800 hours.

TABLE 4

| Element | Si | Fe | Cu | Mn | Mg | Zn | V | Ti | Al | Other |
|---|---|---|---|---|---|---|---|---|---|---|
| Weight | ≤0.25 | ≤0.40 | ≤0.05 | ≤0.05 | ≤0.05 | 2.0-6.0 | ≤0.05 | ≤0.03 | the rest | ≤0.03 |
| percentage | | | | | | | | | | |

### Embodiment 17

An aluminum plastic film is provided, the aluminum plastic film comprising an aluminum foil layer and a plastic layer compounded on the surface of the aluminum foil layer, wherein the aluminum foil layer material is a 3003 aluminum alloy.

Referring to FIG. 6, the aluminum plastic film is composed of an outer protective layer 2, an aluminum foil layer 1, and an inner heat sealing layer 3 from the outside to the inside. The outer protective layer 2 uses nylon (ON). The inner heat seal layer 3 is a cast polypropylene film (CPP). The inner heat-seal layer 3 also serves as an insulation to maintain electrical insulation between the aluminum foil layer 1 and the internal electrolyte. The outer protective layer 2, the inner heat-seal layer 3 and the aluminum foil layer 1 are respectively bonded by the adhesives 4, 5. The outer protective layer 2 serves to protect the aluminum foil layer 1 during deep drawing. The adhesive layer is composed of any of the following resins, which are polyester-urethane resins, polyether-urethane resins, isocyanate resins, and unsaturated carboxylic acid-grafted polyolefin resins.

In the above, the aluminum foil layer 1 can also be replaced with other rust-proof aluminum, such as 5 series anti-rust aluminum or other 3 series anti-rust aluminum. More specific examples are: 3004, 3005, 3105, 5052, 5086, etc. Aluminum foil layer 1 can also be replaced with 6 series aluminum alloy, such as 6063. Of course, the aluminum foil layer may also be pure aluminum, which is a 1050 aluminum alloy, or a 1060 aluminum alloy, or an 1100 aluminum alloy, or an improved version based on the above-described basic model of pure aluminum. These pure aluminum also have good corrosion resistance.

The soft-packed battery formed by the aluminum plastic film can be directly immersed in the coolant and has a long-term corrosion resistance to the coolant, wherein the coolant is preferably a water-based coolant containing ethylene glycol and/or propylene glycol. During the formation of the soft-packed battery, a deep-drawing process is required, and the outer protective layer 2 provides protection to the aluminum foil layer 1 during this deep-drawing process. After the soft pack battery is immersed in the coolant for a period of time, the nylon layer 2 may swell and dissolve and peel, but this does not affect the insulation, sealability and long-term corrosion resistance of the aluminum plastic film. Since the aluminum plastic film of the soft-pack battery has a long-term resistance to the corrosion of the coolant, the soft-pack battery can be directly immersed in the coolant for cooling. The beneficial effect of this is that the heat exchange efficiency of the soft pack battery is very high, and it will not be overheated even when working with high current, which can increase the power density and reliability of the entire battery system.

Compared to 8 series aluminum alloys, 3 series or 5 series rust prevention aluminum have better resistance to corrosion resistance of antifreeze, and its corrosion resistance is longer and more reliable.

### Embodiment 18

This embodiment describes the use of the aluminum plastic film wrapped soft-packaged polymer lithium-ion battery described in Embodiment 17. This embodiment is substantially the same as embodiment 5. The difference is that the aluminum foil in the aluminum plastic film used for packaging soft-pack batteries is formed of a single-layered aluminum alloy, which is formed of a rust-proof aluminum foil, such as 3003 aluminum foil.

### Embodiment 19

This embodiment describes the use of the aluminum plastic film described in Embodiment 17 to wrap the soft polymer lithium ion battery. This embodiment is substantially the same as embodiment 5. The difference is that the aluminum foil in the aluminum plastic film used for packaging the soft-pack battery is formed of a single-layer aluminum alloy. The single-layer aluminum alloy is formed from a 1 series aluminum alloy foil, such as an O-state 1050 aluminum foil or other pure aluminum.

### Embodiment 20

This embodiment describes an aluminum plastic film in which aluminum foil is compositely formed of a core material and an outer skin material. Wherein the core material is formed of an 8-series aluminum alloy (such as 8079 or 8021) of 150 micrometers to 300 micrometers, and the outer skin material is made of a 7 series aluminum alloy (such as 7072), and the composite ratio is taken as 20% to 50%. Further, the 8 series aluminum alloy and the 7 series aluminum alloy are composited and then heated or annealed so that the Zn element appropriately diffuses to form a gradient potential change. The aluminum plastic film containing such a composite aluminum alloy has relatively good corrosion resistance and deep drawability. According to the method of Embodiment 7, it has a corrosion-resistant life of more than 1,500 hours.

### Embodiment 21

This embodiment describes an aluminum plastic film formed by bonding a thermoplastic film (such as CPP), an aluminum foil layer, and a Teflon film from the inside to the outside. Because the Teflon film has good water and corrosion resistance, the soft pack battery made of the aluminum plastic film can be immersed in water or antifreeze solution for a long time.

### Embodiment 22

Reference may be made to Embodiment 7, but the pH of the OY aqueous solution selected in this embodiment is approximately 11. This embodiment is the same as Embodiment 7 except that the pH of the OY aqueous solution is different from that of Embodiment 7. In the embodiment of the present invention, an aluminum foil with a corrosion-resistant life of more than 1,000 hours is selected for the aluminum plastic film for battery packaging materials.

### Embodiment 23

In this embodiment, a corrosion resistance comparison test is performed on a single layer of 1050 aluminum alloy and a composite layer aluminum alloy (core material is 1050 aluminum alloy, and the skin material is a sacrificial layer having a relatively negative potential) in an OY experiment.

The antifreeze system is selected for OY experiments. The experimental time is 4 weeks. After the experiment, the surface of the material is immersed in nitric acid to remove corrosion products, as follows:

As shown in FIG. 7, after a 4-week OY test in an antifreeze system, the left picture shows that the AA1050 single-layer aluminum alloy has obvious pitting corrosion and pitting corrosion is serious. The right picture shows that there is no obvious pitting on the aluminum alloy surface of the composite sacrificial layer. It can be seen that the occurrence of pitting corrosion can be effectively suppressed by compounding the skin material with a negative corrosion potential on the surface of the aluminum alloy core material. After heat-sealing the inner plastic layer of the aluminum plastic film formed of the aluminum foil of the above composite layer, the corrosion resistance time of the aluminum foil-resistant cooling water can meet the automotive requirements. At the same time, since the core material inside the aluminum foil is pure aluminum, its electrolyte corrosion resistance is also superior to the traditional iron-aluminum alloy, thereby ensuring the battery life and safe use.

The specific embodiments of the present invention have been described in detail above, but these are only embodiments, and the present invention is not limited to the above-described specific embodiments. Any equivalent modifications and substitutions made to the present invention by those skilled in the art are also within the scope of the present invention. Therefore, all equivalent changes and modifications made without departing from the spirit and scope of the present invention should be covered by the scope of the present invention.

1. A battery packaging material formed of a metal-plastic composite film, comprising a metal foil layer and a plastic layer laminated to the inner surface of the metal foil layer, wherein the plastic layer is laminated only on the inner side of the metal foil layer.

2. The battery packaging material according to claim 1, which is an aluminum plastic film comprising an aluminum foil layer and a plastic layer laminated on the inner surface of the aluminum foil layer, wherein, the aluminum foil layer is a single-layer aluminum foil, and the aluminum foil layer is formed of an aluminum alloy that is resistant to cooling water or an antifreeze solution; and the aluminum alloy that is resistant to cooling water is selected from 3 series aluminum alloy or 1 series aluminum alloy.

3. The battery packaging material according to claim 1, which is an aluminum plastic film comprising an aluminum foil layer and a plastic layer laminated on the inner surface of the aluminum foil layer; wherein the aluminum foil layer is a composite layer aluminum foil, the aluminum foil layer includes a core material and a skin material located on the outside of the core material, the corrosion potential of the skin material of the aluminum foil layer is lower than the corrosion potential of the core material.

4-5. (canceled)

6. The battery packaging material according to claim 3, wherein the core material of the composite layer aluminum foil is a 1 series aluminum alloy or an 8 series aluminum alloy, and the skin material of the composite layer aluminum foil is formed by adding 1% to 10% by mass of zinc element on the basis of a 1 series aluminum alloy or an 8 series aluminum alloy.

7. The battery packaging material according to claim 18, wherein the aluminum foil in the aluminum plastic film or the aluminum plastic film has a stamping depth value or cupping value of more than 5 mm.

8. The battery packaging material according to claim 1, wherein the plastic layer is laminated only on the inner side of the aluminum foil layer, and the inner plastic layer is a thermoplastic resin film.

9. The battery packaging material according to claim 1, wherein the aluminum plastic film or its aluminum foil has an OY aqueous solution corrosion resistant life of more than 500 hours.

10. The battery packaging material according to claim 1, which is formed by compounding a metal foil and a thermoplastic resin film inside the metal foil; wherein, the metal foil is a single-layer metal of stainless steel foil, or the metal foil is a composite layer metal foil containing a core material and a skin material located on the outside of the core material, and the corrosion potential of the skin material is lower than the corrosion potential of the core material.

11. A soft-pack battery comprising an electrode material and an electrolyte, and a battery packaging material according to claim 1 for external packaging, the soft-pack battery body has the following resistance to coolant corrosion: the corrosion resistance test method is an OY aqueous solution corrosion test; the body of the soft-pack battery is soaked in an aqueous solution, and the corrosion resistance life of the soft-pack battery in the above test is greater than 500 hour, and the plastic layer on the inner surface of the metal foil layer isolates the electrolyte from the metal foil layer.

12. (canceled)

13. A soft-pack battery thermal control device, wherein the soft-pack battery is packaged using the battery packaging material comprising a metal foil layer and a plastic layer laminated to the inner surface of the material foil layer, wherein the plastic layer on the inner surface of the metal foil layer isolates the soft-pack battery electrolyte from the metal foil layer, the soft-pack battery is capable of direct heat exchange with a water-based coolant.

14. The soft-pack battery thermal control device of claim 13 further comprising a partition and a water-based coolant, at least part of the surface of the partition is in direct contact with at least part of the outer surface of the soft-pack battery, and a fluid passage is provided in the partition, a plurality of soft-pack batteries constitute a battery unit, and the battery units are spaced from the partition, the water-based coolant flows in the fluid passage in the partition, and the water-based coolant directly contacts the soft pack battery for heat exchange.

15. The soft-pack battery thermal control device according to claim 14, wherein the partition is made of a metal material, the corrosion potential of the partition is equal to or less than the corrosion potential of the aluminum foil in the aluminum plastic film, or the corrosion potential of the partition is equal to or less than the corrosion potential of the skin material of the aluminum foil of the aluminum plastic film.

16. (canceled)

17. The battery packaging material according to claim 6, wherein the composite layer aluminum foil is heated at a high temperature, and a zinc element in the skin material gradually diffuses toward the core material, thus from the outside to the inside of the aluminum foil layer, the zinc content continuously changes, and the corrosion potential continuously changes, avoiding the zinc element content and the corrosion potential cliff-like change or abrupt change, which is more conducive to the transformation of corrosion morphology into uniform layer corrosion.

18. The soft-pack battery thermal control device according to claim 13, wherein the soft-pack battery is packaged using the battery packaging material which is an aluminum plastic film comprising an aluminum foil layer and a plastic layer laminated on the inner surface of the aluminum foil layer, wherein, the aluminum foil layer is a single-layer aluminum foil, and the aluminum foil layer is formed of an aluminum alloy or pure aluminum that is resistant to cooling water or an antifreeze solution; and the aluminum alloy that is resistant to cooling water or antifreeze is selected from 3 series aluminum alloy or 1 series aluminum alloy.

19. The soft-pack battery thermal control device according to claim 13, wherein the soft-pack battery is packaged using the battery packaging material which is an aluminum plastic film comprising an aluminum foil layer and a plastic layer laminated on the inner surface of the aluminum foil layer; wherein the aluminum foil layer is a composite layer aluminum foil, the aluminum foil layer includes a core material and a skin material located on the outside of the core material, the corrosion potential of the skin material of the aluminum foil layer is lower than the corrosion potential of the core material.

20. The soft-pack battery thermal control device according to claim 19, wherein the core material of the composite layer aluminum foil is a 1 series aluminum alloy or an 8 series aluminum alloy, and the skin material of the composite layer aluminum foil is formed by adding 1% to 10% by mass of zinc element on the basis of a 1 series aluminum alloy or an 8 series aluminum alloy.

21. The soft-pack battery thermal control device according to claim 20, wherein the composite layer aluminum foil is heated at a high temperature, and a zinc element in the skin material gradually diffuses toward the core material, thus from the outside to the inside of the aluminum foil layer, the zinc content continuously changes, and the corrosion potential continuously changes, avoiding the zinc element content and the corrosion potential cliff-like change or abrupt change, which is more conducive to the transformation of corrosion morphology into uniform layer corrosion.

22. The soft-pack battery thermal control device according to claim 13, wherein the soft-pack battery is packaged using the battery packaging material which is formed by compounding a metal foil and a thermoplastic resin film inside the metal foil; wherein, the metal foil is a single-layer metal of stainless steel foil, or the metal foil is a composite layer metal foil containing a core material and a skin material located on the outside of the core material, and the corrosion potential of the skin material is lower than the corrosion potential of the core material.

23. The soft-pack battery thermal control device according to claim 13, wherein the plastic layer is laminated only on the inner side of the metal foil layer, and the inner plastic layer is a thermoplastic resin film.
